(19) United States
(12) Patent Application Publication
(10) Pub. No.: US 2020/0410827 A1
(43) Pub. Date: Dec. 31, 2020

(54) METHOD FOR ELECTRONICALLY CONTROLLING A MOTOR

(71) Applicant: SOMFY ACTIVITES SA, Cluses (FR)

(72) Inventors: Sébastien Lemaître, Mieussy (FR); Serge Bruno, Marnaz (FR)

(73) Assignee: SOMFY ACTIVITES SA, Cluses (FR)

(21) Appl. No.: 16/956,711

(22) PCT Filed: Dec. 26, 2018
(86) PCT No.: PCT/EP2018/086877

§ 371 Date: Sep. 11, 2020

(30) Foreign Application Priority Data
Dec. 27, 2017 (FR) 1763235

(51) Int. Cl. G08B 3/10; H02P 31/00; H02P 23/00; A01M 29/18; B06B 1/04; B06B 1/02; H02P 27/08

(52) U.S. Cl. CPC G08B 3/10; H02P 31/00; H02P 23/0004; H02P 27/08; B06B 1/04; B06B 1/0269; A01M 29/18

(57) ABSTRACT

The invention relates to a method for electronically controlling the power supply to a multi-phase motor, said method comprising: supplying at least one phase of the motor with a suitable first periodic or pseudo-periodic electrical signal such that the electric motor and/or a structure linked to the motor emits a first sound signal, the above-mentioned first signal being supplied while a rotor of the motor is maintained immobile relative to a stator of the motor.

The invention relates to a method for controlling the supply of electric power to a motor. The invention also relates to an electronic control device for controlling the supply of power to a motor. The invention also relates to an actuator. The invention also relates to an actuator system. The invention also relates to a computer program product. The invention relates lastly to a data recording medium.

In many technical fields, such as, non-exhaustively, home automation, the automotive industry or household appliances, it is necessary for equipment to emit information to other equipment and/or to users and/or to third parties, in particular alarms. Information may possibly be transmitted to these users via other equipment. The nature of the information may be varied, such as for example reporting a status, an event or even being used to diagnose equipment.

The users generally perceive the information visually or audibly. Visual information is for example displayed using a screen or indicator lights or projection means. Sound information is for example emitted using a loudspeaker, a piezoelectric element or a buzzer. This information may have been transmitted by a material (cable) or immaterial (radio wave, RFID, optical) means by way of visualization or sound emission. This information therefore requires additional technical means dedicated to emitting and/or viewing the information.

The aim of the invention is to provide a method for controlling an electric motor that makes it possible to rectify the mentioned drawbacks and to improve the control methods known from the prior art. In particular, the invention proposes a method for controlling an electric motor that allows information to be emitted from the motor, in particular for the attention of a user and/or of a third party.

According to the invention, the method for electronically controlling the supply of electric power to a polyphase motor comprises supplying power to at least one phase of the motor with a first periodic or pseudo-periodic electrical signal capable of causing the electric motor and/or a structure linked to the motor to emit a first sound signal, the supply of power taking place while a rotor of the motor is kept stationary in relation to a stator of the motor.

The motor may be kept stationary:
by supplying power to several phases of the motor with a first electrical signal generating, in the motor, a magnetic field rotating at a frequency greater than the stall frequency of the motor; and/or
by supplying power to the at least one phase of the motor with a first electrical signal generating, in the motor, a static and pulsating magnetic field; and/or
by supplying power to several phases of the motor with a first electrical signal generating, in the motor, two magnetic fields rotating in opposite directions at the same frequency; and/or
by blocking the rotor by way of a brake or any other blocking member; and/or
by braking or by loading the motor so as to increase the resistance of the load driven by the motor.

The method may comprise defining a first frequency of a first portion of the first electrical signal on the basis of a first portion of the first sound signal to be emitted by the motor and/or the structure and supplying power to the motor with the first portion of the first electrical signal at the defined first frequency.

The method may comprise defining a second frequency of a second portion of the first electrical signal on the basis of a second portion of the first sound signal to be emitted by the motor and/or the structure and supplying power to the motor with the second portion of the first electrical signal at the defined second frequency.

The method may comprise defining several different electrical signals capable of causing the motor and/or the structure to emit several sound signals without a rotor of the motor rotating in relation to a stator of the motor, each sound signal being associated with particular information intended for a user, in particular:
information confirming a setting or a configuration, in particular an end position setting, pairing with a remote control,
fault information,
error information,
anomaly information.

The method may comprise defining an electrical signal allowing the motor and/or the structure to emit an animal deterrence sound signal without the rotor of the motor rotating in relation to the stator of the motor, in particular an ultrasonic sound signal.

The method may comprise defining an electrical signal allowing the motor and/or the structure to emit an alarm sound signal without the rotor of the motor rotating in relation to the stator of the motor, in particular an electrical signal allowing the electric motor and/or the structure, in particular a roller shutter or a blind, to resonate.

The method may comprise defining the first electrical signal having a frequency evolving progressively over an entire frequency range, in particular a range extending from 500 Hz to 10 000 Hz, or even from 1000 Hz to 5000 Hz.

The method may comprise a configuration phase in which:
a second electrical signal having a frequency evolving progressively over an entire frequency range extending from 500 Hz to 10 000 Hz, or even from 1000 Hz to 5000 Hz, is defined;
the motor is supplied with power by the second electrical signal;
the user indicates the time when the motor and/or the structure emits a sound that is suitable for said user while the motor is supplied with power by the second electrical signal;
the frequency of the second electrical signal corresponding to the time indicated by the user is recorded as the frequency of the first electrical signal to be used to subsequently emit the first sound signal.

The first electrical signal may be a signal sampled at a frequency greater than or equal to 16 kHz, or even greater than or equal to 20 kHz, or even greater than or equal to 40 kHz, or even greater than or equal to 50 kHz, or even approximately 100 kHz, or the first electrical signal may be a polyphase signal each phase of which is supplied with power by a signal sampled at a frequency greater than or equal to 16 kHz, or even greater than or equal to 20 kHz, or even greater than or equal to 40 kHz, or even greater than or equal to 50 kHz, or even approximately 100 kHz.

The first electrical signal may be a trapezoidal signal or a pseudo-sinusoidal signal or a sinusoidal signal or the first electrical signal may be a three-phase signal each phase of which is trapezoidal or pseudo-sinusoidal or sinusoidal.

The motor may be a three-phase electric motor and the first power supply signal may be generated by a three-phase inverter, in particular a three-phase inverter with controlled switches and/or a three-phase inverter with PWM-controlled switches and/or a three-phase inverter with six controlled switches.

According to the invention, an electronic control device for controlling the supply of power to a motor, in particular an inverter, in particular a three-phase inverter with controlled switches and/or a three-phase inverter with PWM-controlled switches and/or a three-phase inverter with six controlled switches, comprises hardware and/or software elements implementing the method as defined above, in particular hardware and/or software elements designed to implement the method as defined above, and/or the device comprising means for implementing the method as defined above.

According to the invention, an actuator comprises a mechanical structure comprising a resonant element resonating at a given frequency, in particular a frequency between 500 Hz and 10 000 Hz, or even between 1000 Hz and 5000 Hz.

According to the invention, an actuator system comprises an electronic control device as defined above and an actuator, in particular a three-phase electric motor and/or an actuator as defined above.

The invention also relates to a computer program product able to be downloaded from a communication network and/or recorded on a data medium able to be read by a computer and/or able to be executed by a computer, comprising computer program code instructions for implementing the method as defined above when the program is executed by a computer and/or comprising instructions that, when the program is executed by a computer, prompt same to implement the method as defined above.

The invention also relates to a data recording medium, able to be read by a computer, on which there is recorded a computer program comprising program code instructions for implementing the method as defined above or a computer-readable recording medium comprising instructions that, when they are executed by a computer, prompt same to implement the method as defined above.

The invention will be better understood upon reading the following description of embodiments, given solely by way of example and with reference to the appended drawings, in which:

FIG. 1 is a longitudinal section of one embodiment of a motor.

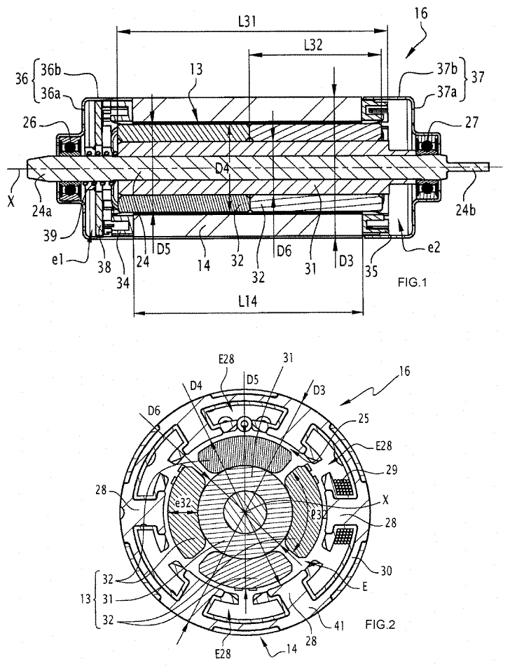

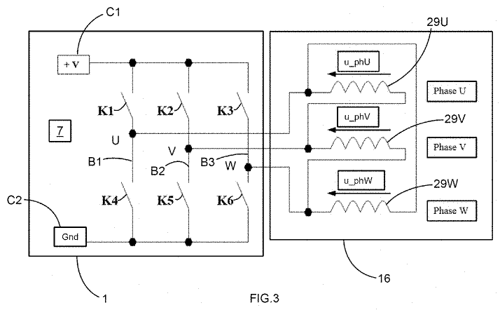

FIG. 2 is a cross section of the embodiment of the motor.

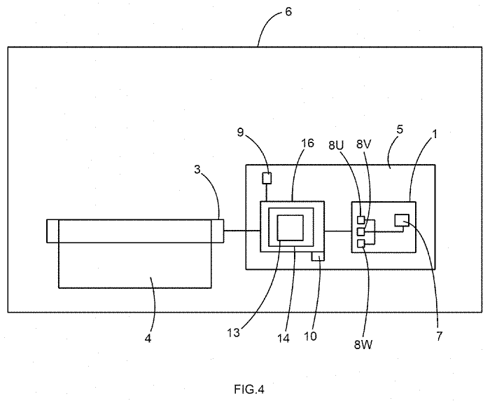

FIG. 3 is a circuit diagram of a first embodiment of a motor supplied with power by an inverter.

FIG. 4 is a diagram of a home automation installation comprising the embodiment of the motor.

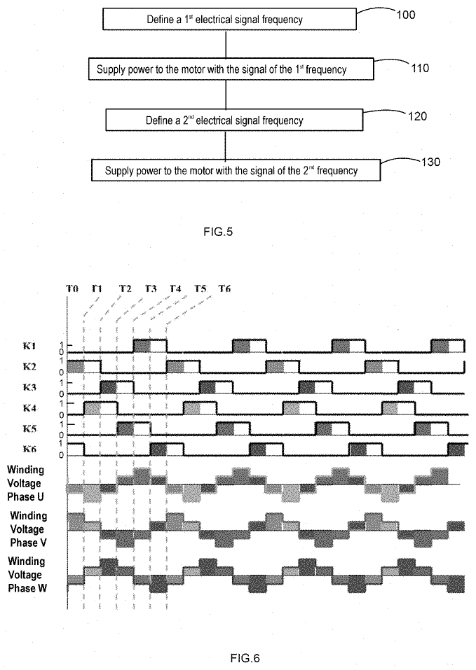

FIG. 5 is a flowchart of one execution mode of a control method.

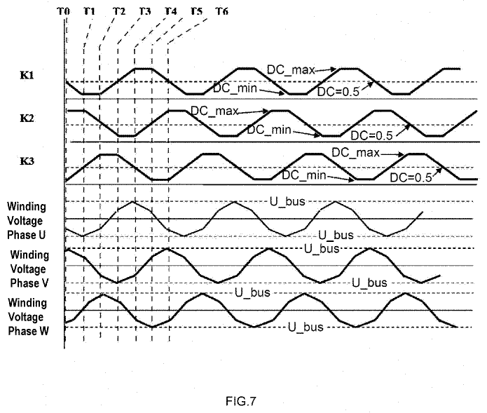

FIG. 6 is a timing diagram of a first example of controlling an inverter and of signals for supplying power to a three-phase motor.

FIG. 7 is a timing diagram of a second example of controlling an inverter and of signals for supplying power to a three-phase motor.

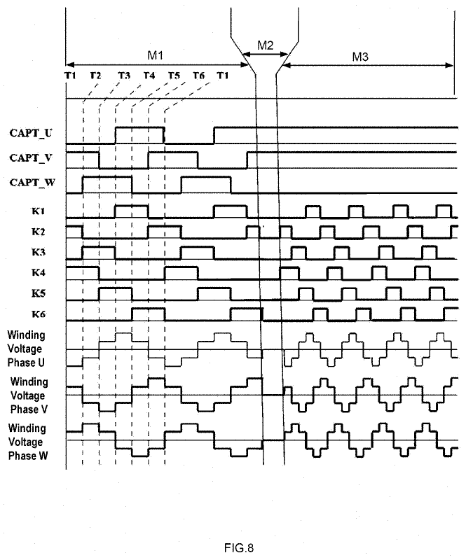

FIG. 8 is an example of signals for supplying power to a three-phase motor, the motor being supplied with power so as to rotate in a first mode, and then supplied with more power in a second mode, and then supplied with power so as to emit a sound (without rotating) in a third mode.

FIG. 9 is a timing diagram of the strength of a supply current to a motor whose supply voltage evolves between 500 Hz and 5000 Hz over a period of one second.

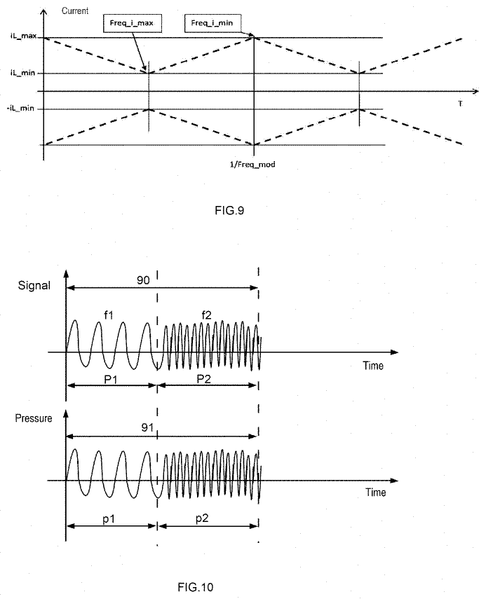

FIG. 10 is a timing diagram of a signal for supplying power to the motor and of a sound signal produced as a result of this power supply signal.

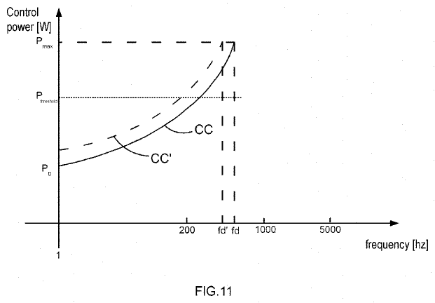

FIG. 11 is a stall characteristic diagram of a motor.

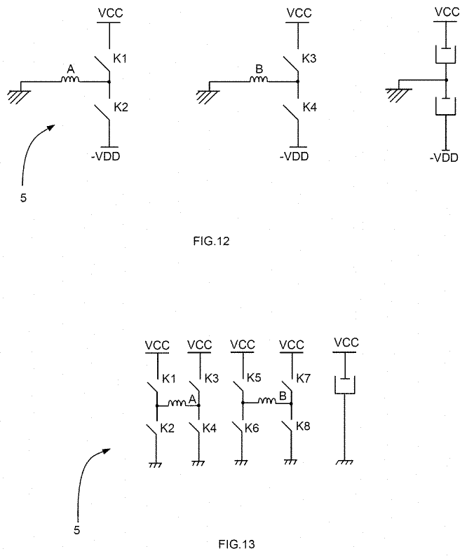

FIG. 12 is a circuit diagram of a second embodiment of a motor supplied with power by an inverter.

FIG. 13 is a circuit diagram of a third embodiment of a motor supplied with power by an inverter.

One embodiment of an installation 6 is described below with reference to FIGS. 1 to 4.

The installation comprises an actuator system 5 and a mobile element 3, 4.

The actuator system 5 comprises an electronic control device 1, in particular an inverter, and an electric motor-type actuator 16.

Generally speaking, the electronic control method that is the subject of the invention applies to electronically controlled polyphase motors.

A motor typically consists of a stator, which is by definition fixed and on which a winding of copper wire is formed, and of a rotor, which is by definition mobile in relation to the stator. The rotor may itself also be wound, or be equipped with magnets, or even made from ferromagnetic metal sheets. The geometry of the assembly may be variable: the stator may surround the rotor (the most common case, reference is made to a centered rotor), or else the rotor may be around the stator (reference is then made to a bell-shaped rotor or external rotor), or else the two elements may face one another. The supply of electric power to the windings of the stator generates a magnetic field that allows the rotor to be set in motion.

The motor is preferably a brushless magnet motor or a wound-rotor or permanent-magnet synchronous-reluctance motor. It may also be a starter-alternator. The motor may also be an asynchronous motor or a synchronous-reluctance motor. The electronic control method applies to polyphase motors regardless of the phase connection configuration, such as for example motors whose windings are connected in delta or in star or even two-phase motors.

In the remainder of the description of the embodiment, the electric motor 16 is for example a polyphase motor (or BLDC motor, to use the acronym for “BrushLess Direct Current”).

The motor 16 comprises a rotor 13 including a rotor body 31 provided with magnetic elements 32 and a stator 14. The stator surrounds the magnetic elements 32 of the rotor. The rotor is mounted so as to be able to move in rotation in the stator about an axis X. The rotor is for example guided in the bearing by rollers 26 and 27.

The magnetic elements 32 are arranged on the outer circumference of the rotor body 31. The magnetic elements 32 of the rotor 13 are for example ferrite permanent magnets.

The magnetic elements 32 are separated from the stator 14 by an air gap 25 that is radial with respect to the axis of rotation X. The magnetic elements or permanent magnets 32 may be attached to the outer circumference of the rotor body 13 by adhesive bonding, overmolding or any other known technique. The rotor body 31 is connected to a rotor shaft 24 so as to rotate therewith. The rotor shaft 24 is centered on the axis of rotation X and protrudes on either side of the rotor body 31.

Advantageously, the rotor body 31 is formed from a stack of metal sheets. In another embodiment, the rotor body 31 is formed by a solid shaft. In another embodiment corresponding to the case of a hollow rotor, the rotor body 31 is produced in the form of a stamped bell.

For example, use is made of four magnets each forming a magnetic element 32 and distributed around the rotor body 31, thus forming a four-pole rotor 13.

The stator 14 is formed by a stator core 41 made of magnetizable material, more specifically of ferromagnetic material, that is generally formed by a stack, or bundle, of metal sheets and provided with insulating linings. The stator core 41 comprises pole elements 28 distributed over a peripheral wall 30 of the stator core 41, preferably on the inside of the peripheral wall 30 of the stator core 41. The stator 14 is obtained from a stator core 41 comprising a stack of metal sheets each forming a closed circumference, to which a winding assembly is attached. In FIG. 2, a single winding 29 is shown in place around a single pole element 28, in order to clarify the drawing. The pole elements 28 of the core 41 protrude toward the inside of the electric motor 16, from the peripheral wall 30. For example, there are six of them in number, distributed uniformly over the peripheral wall 30, thus forming a six-pole stator 14. The space E28 formed between two adjacent pole elements 28 is called a notch. Windings 29 are positioned in the notches around the pole elements 28 of the stator 14. Preferably, each pole element 28 is surrounded by a winding 29 that is specific thereto. It is nevertheless possible to have only a partial winding, such as for example a winding on one pole element out of two. These windings 29 are such that they have the same number of turns per pole element. The windings 29 of the diametrically opposite pole elements are connected at the ends of the stator core 41 so as to form a phase. As the six windings 29 are connected in pairs, the stator 14 therefore comprises three phases, in particular forming a delta configuration. The windings 29 are connected such that, when they are flowed through by a current, they produce a rotating magnetic field that drives the rotor 13 in rotation. The windings 29 are electrically insulated from the stator core 41 by an insulating element.

Advantageously, the pole elements 28 of the stator core 41 comprise, at the end of a tooth 28a projecting with respect to the peripheral wall 30 of the stator 14, an expansion 28b in the stack of metal sheets forming the stator core 41.

The electronic control method uses any type of electronic control that allows a magnetic field to be generated in a wound stator. The control may for example comprise trapezoidal or sinusoidal or pseudo-sinusoidal power supply signals.

The electronic control device 1 comprises a plurality of output terminals U, V, W configured so as to be electrically connected to a plurality of input terminals of the polyphase motor 16. In the example illustrated in FIG. 3, the electronic control device 1 comprises three output terminals intended to be electrically connected to three input terminals of the three-phase electric motor.

Of course, this example is in no way limiting and the electric motor 16 may be a two-phase-current electric motor or any other type of polyphase-current electric motor comprising a greater number of phases.

As seen above, the electronic control device 1 is a polyphase inverter configured so as to sequentially deliver electrical signals between two output terminals taken from among the plurality of output terminals.

The inverter has a plurality of branches B1, B2, B3 electrically connected in parallel between a first connection point C1 and a second connection point C2. Each branch B1, B2, B3 comprises a first electronic switch K1, K2, K3 electrically connected to the first connection point C1 and electrically connected in series with an associated second electronic switch K4, K5, K6. The second electronic switch is electrically connected to the second connection point C2. Simultaneously switching a first electronic switch and a second electronic switch other than its associated electronic switch makes it possible to supply power to at least one winding 29U, 29V, 29W of the motor.

The electronic switches K1 to K6 or controlled switches are preferably transistors.

In the example of FIG. 3, the inverter that is shown is a three-phase inverter and the motor is a three-phase electric motor, the windings 29U, 29V, 29W of which are electrically connected in a delta configuration. This exemplary configuration is in no way limiting. The windings of the motor 16 may be electrically connected in a star configuration.

A first connection point C1 of the inverter is electrically connected to a first terminal +V of an electrical energy source and a second connection point C2 is electrically connected to a second terminal Gnd of the power source, in particular via a current sensor.

Each branch B1, B2, B3 of the inverter comprises a center tap electrically connected to an output terminal.

The first electronic switches K1, K2, K3 are distributed in a first group of switches and the second electronic switches K4, K5, K6 are distributed in a second group of switches.

The switching of the electronic switches K1, K2, K3, K4, K5, K6 is controlled by control signals generated by the control unit 7, forming a predetermined control law. The control law is broken down into a succession of switching sequences, each sequence corresponding to a set of signals for a determined duration. Upon each instance of switching of a first electronic switch K1, K2, K3 and of a second electronic switch other than its associated switch K4, K5, K6 from its off state to its on state, at least one of the windings E1, E2 and E3 of the motor is supplied with power. The control law is programmed such that the inverter sequentially delivers a voltage between two output terminals taken from among the plurality of output terminals of the electronic control device 1.

When the input terminals of the electric motor 16 are electrically connected to the output terminals of the electronic control device 1, the electrical signals delivered by the inverter are programmed so as to sequentially supply power to the windings of the stator of the polyphase electric motor in order to generate a rotating electrical field capable of driving the rotor in rotation in the normal or nominal operating mode of the motor.

The control unit may comprise a microprocessor or a microcontroller. This control unit may be programmed or designed so as to produce a command for controlling the controlled switches at a frequency greater than or equal to 16 kHz, or even greater than or equal to 20 kHz, or even greater than or equal to 40 kHz, or even greater than 50 kHz, or even of the order of 100 kHz, in particular a command using a pulse width modulation technique (PWM for Pulse Width Modulation) at a frequency greater than or equal to 16 kHz, or even greater than or equal to 20 kHz, or even greater than or equal to 40 kHz, or even greater than 50 kHz, or even of the order of 100 kHz. Thus, the first electrical signal is a signal sampled at a frequency greater than or equal to 16 kHz, or even greater than or equal to 20 kHz, or even greater than or equal to 40 kHz, or even greater than 50 kHz, or even of the order of 100 kHz, or the first electrical signal is a three-phase signal each phase of which is sampled at a frequency greater than or equal to 16 kHz, or even greater than or equal to 20 kHz, or even greater than or equal to 40 kHz, or even greater than 50 kHz, or even of the order of 100 kHz. As explained further below, it is beneficial to have the highest possible control or driving frequency for controlling or driving the switches. However, high frequencies pose thermal and economic constraints.

The number of controlled switches may be different. For example, the electronic control device may comprise fewer than six controlled switches or more than six controlled switches, in particular four controlled switches or eight controlled switches. In particular, four or eight controlled switches may be used to control a two-phase motor.

The electronic control device 1, in particular the control unit 7, comprises hardware and/or software elements that govern its operation, in particular the hardware and/or software elements comprise all of the means for implementing the electronic control method that is the subject of the invention, in particular the execution modes of the electronic control method that are described further below. The hardware and/or software elements may comprise software modules.

Other examples of actuator systems 5 are described below with reference to FIGS. 12 and 13. They relate to actuator systems 5 comprising a two-phase motor including a first winding A and a second winding B.

A first example comprises an inverter with four controlled switches that are mounted in relation to the windings A and B as illustrated in FIG. 12.

A second example comprises an inverter with eight controlled switches that are mounted in relation to the windings A and B as illustrated in FIG. 13.

The method according to the invention proposes to use a polyphase motor of an installation as a means for generating vibrations while keeping the rotor of the motor stationary. The vibrations are transmitted from the motor to a surrounding structure to which the motor is linked. The vibrations are radiated in the form of noise by the motor and/or the structure. The method therefore makes it possible to emit airborne noise without adding any additional physical element or modifying physical elements of an existing installation.

The structure includes all of the elements connected directly or indirectly to the motor and liable to emit an audible or inaudible sound when passed through by the vibrations generated by the motor, the motor itself being able to be counted among the noise-radiating structural elements.

Finally, the invention also relates to a control program or algorithm capable of using the motor as a generator for generating vibrations without rotation of the rotor, which vibrations propagate gradually in the structure of the installation. The mentioned structure may comprise the mobile element to be driven, the support 10 on which the motor rests or even another exogenous element or element attached to the motor or to the support or to the mobile element. This structure, with the motor itself, constitutes a means for emitting airborne noise from structure-borne noise. In order to maximize the noise level, it is contemplated to bring about resonance of the structure and/or the motor. Said resonance may be determined at the time of design or else during supervised learning.

Generally speaking, it is possible to design the motor so that there is no spatial and temporal coincidence between the excitation and the structure of the motor. The excitation is characterized by numbers of spatial waves and frequencies. The structure is characterized by natural modes and natural frequencies. During normal operation, that is to say when the motor is supplied with power such that its rotor rotates, it is sought to clearly separate the two in order to reduce the noise level. On the other hand, in one particular operating mode in which the aim is to maximize noise and vibrations, it is possible to tune the excitation and the structure in order to maximize the response.

In normal or nominal operating mode of the motor, the motor is self-driven or subjected to closed-loop control, the signals injected into the motor being determined by the position of the rotor in the stator. One or more position sensors are used. The sensors are physical or virtual. Specifically, virtual sensors may be calculation means that make it possible to reconstruct information about the position of the rotor of the motor in relation to the stator from other features of the motor (current for example). The electric power supply signal is applied to the motor on the basis of the position of the stator. Sensor signals CAPT_U, CAPT_V and CAPT_W are shown and determine for example the states of the controlled switches K1 to K6 defining the supply of power to the motor. To this end, the electronic control device advantageously comprises sensors, in particular sensors 8U, 8V and 8 W, that make it possible to determine the position of the rotor 13 in relation to the stator 14.

Such an operating mode M1 is illustrated in FIG. 8. In such an operating mode, the signals injected into the motor produce a rotating magnetic field in the stator. This magnetic field is followed by the rotor, which itself also produces a magnetic field in the case of a rotor equipped with permanent magnets, or which will close the magnetic field lines in the case of a magnet-free motor (synchronous-reluctance motor for example).

Preferably, the electrical signal is intended here to minimize sound emissions produced by the motor and/or the structure surrounding the motor.

One execution mode of an electronic control method is described below with reference to FIGS. 5 to 8. This electronic control method has the effect of producing noise or sound. This method is thus also a method for producing or generating sound. This control method brings about a particular operating mode of the motor, different from the nominal or normal operating mode. This particular operating mode is characterized by vibrations in the motor while the rotor is stationary or not rotating.

When the motor is supplied with power by a first electric power supply signal having a period or a pseudo-period of a determined duration, it may be seen that the vibrations produced in the motor and/or in the structure surrounding the motor have a period or a pseudo-period of the same or substantially the same duration. The first power supply signal may be a signal obtained by adding several periodic signals having different frequencies (and that are not necessarily multiples of one another). As a result, it is not always possible to identify a period of the first signal. It is however possible to identify a pseudo-period of this first signal.

In this case of supplying power to the motor with a first signal formed by adding several signals having different frequencies, it is possible to create a sound having several frequencies that are emitted simultaneously. It is thus possible to produce several sound notes simultaneously in one and the same command.

In one embodiment, the method comprises generating a magnetic field at the stator whose period or pseudo-period is too small for the rotor to be able to be driven. Specifically, due to the frequency of the power supply signal, the rotor does not manage to attach to the fundamental of the magnetic field generated by the power supply or control signal. As mentioned above, this results in vibrations in the motor while the rotor is immobile or kept stationary.

As a result, the generation of vibrations without rotation of the rotor works only under certain power supply conditions, in particular beyond a certain frequency. This frequency depends on the inertia of the rotor, on the friction in the bearings, on the number of pairs of poles of the motor and on the electrical parameters of the motor (inductance, resistance, counter-electromotive force, etc.). This frequency is called stall frequency. This frequency also depends on the power of the power supply signal. The frequency depends lastly on the resistive torque exerted by the mobile element that forms a load for the motor. One example of a stall characteristic curve CC of a polyphase brushless motor is illustrated by a graph in FIG. 11. As seen above, for a polyphase motor, the stall frequency depends on the power of the power supply signal. It is independent of the frequency of the PWM. The graph shows the power of the power supply signal on the ordinate and the frequency of the power supply signal on the abscissa. For each given power, there is therefore a stall frequency. The range between the characteristic CC and a straight line defined by the maximum power Pmax in FIG. 11 represents all of the power and frequency pairs that allow the rotor of the motor to rotate. When the motor is subjected to an electrical signal whose power and frequency parameter pair is outside this previously mentioned range, the rotor remains stationary. It should be noted that the range of possible parameters of the power supply signal is furthermore limited by the maximum power Pmax that the inverter is able to supply. It is noted in particular that the rotor remains stationary when it is supplied with power by an electrical signal whose parameters are:
below the curve CC; and
to the right of the curve CC, that is to say for a frequency of the power supply signal greater than a frequency fd known as the maximum no-load stall frequency.

It is noted that the motor may therefore be kept stationary by supplying power to the motor at a sufficiently high frequency, in particular a frequency greater than the maximum stall frequency fd. Preferably, it is also possible to use a safety coefficient, for example 5%, to be certain that the motor power supply frequency is greater than the maximum stall frequency.

A duty cycle that may be within a wide range, such as preferably between 10% and 100% (switch closed between 10% and 100% of its time), is used to drive the PWM-controlled switches. Regardless of the frequency at which it is desired to generate vibrations, it is preferable to operate at a duty cycle greater than that which makes it possible to create a limit power supply signal power P0 that allows the rotor to be driven while at the same time moving away from the stall curve by virtue of higher frequencies.

This operating mode makes it possible to generate a sound with an acoustic power such that it is clearly perceived by a human ear when it is within an audible frequency range.

In contrast, a single-phase DC current motor is able to emit only sounds with a low acoustic power because it has to be under-supplied with power, that is to say it is necessary to apply to it a current lower than its starting current so that it is not able to overcome the mechanical resistance provided by the load that is associated therewith. In terms of frequency, this starting current value does not vary much, and therefore the power supplied to the motor in order to start it will not vary much with frequency. As a result, the power injected into the motor in order to be able to make it emit a sound without it starting up is limited to a power range lower than this starting power, hence sounds with a low acoustic power.

As mentioned above for a given motor, the change in resistance of the load may move the characteristic curve while limiting the area of the range mentioned above. One example of movement is illustrated by the dotted curve CC′. This movement is due to an increase in mechanical resistance. Thus, in comparison with the characteristic curve of the motor at no-load, it is possible to observe a decrease in the operating area through a shift of the stall curve to the left and upward in the graph.

The maximum stall frequency fd is preferably defined as the limit frequency at which the motor stalls when it is supplied with its maximum or nominal operating power. As an alternative, the stall frequency fd is preferably defined as the limit frequency at which the motor stalls when it is supplied with the maximum or nominal operating power of the inverter-motor assembly.

It should therefore be noted that it is possible to modify the stall frequency by modifying the mechanical resistance of the load. As indicated in FIG. 11, when the motor is under conditions defining its characteristic CC′, its stall frequency is then fd′.

It is noted that, under the conditions defining the curve CC′, it is therefore possible to keep the motor stationary by supplying power to the motor at a sufficiently high frequency, in particular a frequency greater than the maximum stall frequency fd′. Preferably, it is also possible to use a safety coefficient, for example 5%, in order to be certain that the motor power supply frequency is greater than the maximum stall frequency fd′.

In another embodiment, the method stops the motor by supplying power to a single phase of the motor. The vibration and acoustic level that is obtained is then lower. As an alternative, the motor may be stopped by supplying power to all of the phases at the same time so as to create a pulsating field. It is then typically sought to appropriate a 0-order wave number. The magnetic field produced in the stator is thus static but of variable strength, in particular of periodic strength. Again as an alternative, the motor may be stopped by creating two opposing rotating fields of the same strength.

Lastly, in another embodiment, the method stops the motor by activating a brake, that is to say a means for blocking the rotor. The mobile element driven by the motor may also be a means for blocking the rotor in a certain operating range of the motor. In other words, for given power supply characteristics, the motor may rotate at no-load and not rotate due to the resistance of the load to which it is coupled.

In these various embodiments, since the rotor does not rotate, control is not slaved thereto, whether in terms of position or in terms of speed. In these cases, the polyphase motor is said to be subjected to open-loop control or direct control.

As shown in FIG. 5 in connection with FIG. 10, the method comprises a step 110 of supplying power to the motor with a first electrical signal able to cause the electric motor and/or the structure to emit a first sound signal without the rotor of the motor rotating in relation to the stator of the motor. This supply of power is performed with a first portion of the first signal the first frequency of which is for example high enough such that the motor is not able to rotate. This supply of power is maintained for a duration t1. This supply of power may nevertheless bring about small angular movements of the rotor in relation to the stator. These small movements may not be visible to the naked eye. In any case, these movements have an amplitude less than an angle of 5° or 10°. The supply of power also brings about deformations of the stator and/or of the rotor. All of these phenomena bring about vibrations in the motor that irradiate the surroundings, possibly via the structure, in the form of sounds.

In a phase of supplying power to the motor in order to make it rotate, the inverter is used to generate an electrical signal that generates a rotating magnetic field in the stator of the motor when it supplies power to the windings of the stator. The rotor then rotates at the rotational frequency determined by the frequency of the electrical signal.

In a phase of supplying power to the motor in order to make it produce a sound without rotating, the inverter is used to generate the first electrical signal, thus generating a magnetic field in the stator of the motor when it supplies power to the windings of the stator. The frequency of the first electrical signal is for example greater than the frequency of the signal used to make the motor rotate. The rotor, equipped with magnets, is not able to follow the rotation of the rotating magnetic field determined by the frequency of the first electrical signal, in particular due to its inertia and friction. The vibration phenomena and the sounds explained above then occur. The rotor remains immobile or almost immobile and the frequencies present in the sounds are not linked to the rotation of the rotor.

The method for controlling the motor makes it possible to generate forces in the air gap of the motor, the place where electrical energy is converted into mechanical energy. These forces propagate to the structure through vibration. These forces are created without bringing about a perceptible movement of the rotor. This therefore involves creating structure-borne noise that is independent of the movements of the rotor. The magnetic forces are proportional to the square of the magnetic field. The latter is the sum of the field generated by the magnets of the rotor, or by the electromagnet in the case of a wound rotor for example, and the field generated by the windings of the stator. The development of the square shows three terms. The square of the field of the magnets represents a static force and is therefore not involved in the generation of noise. The double product of the field of the magnets and the field of the armature is significantly greater than the square of the field of the windings. It is therefore the magnets, or electromagnets, that give most of the power. As a result, the double product of the magnetic fields brings about forces at the same frequencies as the electrical signal. The frequency of this electrical signal is much lower than that of the PWM that generates it. The ratio between the two frequencies may typically vary between ⅓ and 1/40. Driving in PWM mode generates vibrations at the frequency of the PWM. The emission thereof is then inaudible to the human ear beyond 20 kHz. The invention does not utilize the vibrations generated by the PWM, which have a much lower strength than that of the periodic or pseudo-periodic control signal generated by the electronic control device 1 for controlling the supply of power.

It is the forces explained above that will mostly generate vibrations, and therefore sound. It is thus possible to control the sound by acting directly on the electrical signal. The intensity of this sound depends only on the second order of the strength of the current flowing in the windings of the stator. The vibratory power is essentially given by the magnetic field of the magnets or electromagnets. Finally, due to the impedance of the circuit, it should be noted that, for a given supply voltage, the strength of the current varies with the frequency of the signal, as in the example shown in FIG. 9.

Finally, if the sound production method is based on using a rotating magnetic field generated by the windings of the stator coupled to the static field of the magnets, the production of vibrations is independent of the position of the rotor in relation to the stator or at least the sound volume level appears to the human ear to be independent of the position of the rotor of the motor. It is therefore possible to produce sounds without worrying about the position of the rotor of the motor. Moreover, vibrations and sounds are generated without a preferred spatial direction.

Prior to step 110 described above, in which the motor is supplied with power by a first portion P1 of the first electrical signal 90 at the defined first frequency f1, the method comprises a step 100 of defining this first frequency f1 of the first portion P1 of the first electrical signal 90. This definition is based on a first portion p1 of the first sound signal 91 to be emitted by the motor and/or the structure. For example, the first frequency may be defined as follows. It is assumed that it is desired to emit a sound having a frequency of 1 kHz or a main frequency of 1 kHz. The controlled switches K1 to K6 are then driven so as to generate the first electrical signal at the first frequency equal to 1 kHz.

Preferably, after step 110 or at the same time as step 110, the method comprises a step 120 of defining a second frequency f2 of a second portion P2 of the first electrical signal 90. This definition is based on a second portion p2 of the first sound signal 91 to be emitted by the motor and/or the structure. For example, the second frequency may be defined as follows. It is assumed that it is desired to emit a sound having a frequency of 5 kHz or a main frequency of 5 kHz. The controlled switches K1 to K6 are then driven so as to generate the first electrical signal at the second frequency equal to 5 kHz.

Then, in a step 130, the motor is supplied with power by the second portion P2 of the first electrical signal 90 at the second defined frequency f2. This supply of power is maintained for a duration t2. What is thus obtained is emission of a first sound signal 91 having a first portion p1, of a first duration t1, emitted at a first frequency f1, for example 1 kHz, and then a second portion p2, of a second duration t2, emitted at a second frequency, for example 5 kHz. The first duration t1 may have a value of a few tenths of a second, or even a few seconds and/or the second duration t2 may have a value of a few tenths of a second, or even a few seconds. The first portion P1 of the first electrical signal is applied to the motor for the first duration t1, and then the second portion P2 of the first electrical signal is applied to the motor for the second duration t2.

A description has been given above of a first sound signal comprising a first sound portion, and then a second sound portion, that is to say two sounds emitted sequentially one after the other. Of course, the first sound signal may comprise only a sound portion, that is to say that it is emitted at the same frequency from its start to its end. The first sound signal may alternatively also comprise more than two sound portions, each portion having a frequency or a main frequency different from the frequency of the portion that precedes and from the frequency of the portion that follows the portion under consideration.

Specifically, it is possible to modify the frequency of the first electrical signal sequentially and very quickly. As a result, it is possible to generate a succession of vibrations at precise frequencies. This makes it possible to reproduce a musical score or generate a melody, that is to say a set of musical notes at a defined rhythm. The quality of the sound that is produced largely depends on the frequency at which it is possible to drive the controlled switches K1 to K6. The higher this driving frequency, the better the sound quality. Moreover, by increasing this frequency to a certain value, the vibration or sound level also increases. It is possible to use a first driving frequency for the controlled switches (first PWM frequency) in the normal operating mode of the motor allowing the motor to rotate and to use a second driving frequency for the controlled switches (second PWM frequency) in the particular operating mode of the motor allowing sounds to be emitted. As an alternative, the second driving frequency for the switches may be used in both operating modes.

The electronic power supply control method lastly makes it possible to combine and/or sequentially activate electrical signals in order to create a melody.

The PWM driving frequency is chosen depending on the range of vibrations to be created. The higher their frequencies, the higher the PWM driving frequency is in order to obtain sufficient sampling of the sounds to be emitted. The frequency that is chosen is however a compromise between the crispness or the quality of the sound signal, on the one hand, and computing resources, energy consumption, possibilities of heat dissipation and economic constraints, on the other hand.

Advantageously, the method comprises defining several different electrical signals capable of causing the motor and/or the structure to emit several sound signals without the rotor of the motor rotating in relation to the stator of the motor, each sound signal being associated with particular information intended for a user. As a result, each electrical signal is associated with particular information intended for a user.

Each sound signal has its own meaning. The sound signals may in particular be distinguished from one another by their melodies. These various melodies correspond to different information. The actuator thus makes it possible to improve security and user experience by providing new functions. Generating sounds specifically makes it possible to create an acoustic link between the actuator and the user, the sound then being an information vector.

The aim is in some cases to emit a sound meaning or carrying a comprehensible acoustic message, that is to say for example that meaning is given to some melodies. This meaning should not be altered by the device, which constitutes a filter for some frequencies and/or an amplifier for other frequencies.

The first electrical signal is for example a trapezoidal signal, as described below with reference to FIG. 6. The duty cycle is constant. However, as illustrated in FIG. 6, the strength of the current varies periodically over time due to a variation in impedance of the motor when the frequency of the power supply signal varies.

The applicant has found that there was no need to use the maximum power of the inverter in the sound generation phase. Specifically, starting from a defined threshold for each motor, the sound level is at a maximum. It is thus possible to have an increase in the sound level on power levels below this threshold, and then saturation at this maximum level. For the sake of optimizing heating of the motor and therefore indirectly in order to maximize the possible emission duration of a sound, the power of the inverter that is used will be limited to the predefined threshold. Such a threshold power Pthreshold is illustrated in FIG. 11.

It should therefore be noted that the strength of the current supplied to the motor on account of the first electrical signal may be limited in order to reduce energy consumption. As a result, it will be possible to emit a sound, or a melody, for longer for the same level of heating. For example, this may be beneficial if the sound that is emitted is an alarm signal.

However, the first power supply signal to the motor for producing sound is not necessarily a signal for under-supplying power to the motor in order to prevent it from rotating. The choice of the power of the power supply signal is advantageously guided by considerations of energy efficiency and heating in relation to a sound volume that is produced. It is in particular possible to supply power to the motor at a frequency greater than a threshold frequency beyond which it is not able to rotate.

A first example of a first electrical signal is described below with reference to FIG. 6. In this first embodiment, the first electrical signal is a trapezoidal three-phase electrical signal. A period of the first electrical signal is shown between times T0 and T6. This period is divided into six sequences of identical duration, a switching operation of two of the 6 controlled switches taking place at the end of each of the sequences. The signals for driving the 6 controlled switches are also shown. A drive signal in state 1 represents a switch in the on state. This drive logic makes it possible to generate a first electric power supply signal to the motor at a first frequency equal to 1/(T6−T0). The first electrical signal comprises three phase signals producing, at each of the windings of the stator, signals that are phase-shifted by 120° in relation to one another. The three signals at the windings are alternating signals. The strength of the current supplying the windings may be controlled by acting on the duty cycle of the first electrical signal, which is a pulse width modulation signal. In FIG. 6, the various gray levels indicate the different times of the PWM mode of the switches. The gray slots indicate the controlled switches driven using PWM at a constant duty cycle in order to reduce the voltage appropriate for supplying power to the motor.

The example below makes it possible to produce the rotating magnetic field in the stator. As seen previously, it is possible to drive the differently controlled switches so as to vary the magnetic field differently. In particular, it is possible to drive a different number of switches and/or it is possible to differently phase-shift the power supply signals applied to the windings.

A second example of a first electrical signal is described below with reference to FIG. 7. In this second embodiment, the first electrical signal is a pseudo-sinusoidal three-phase electrical signal. A period of the first electrical signal is shown between times T0 and T6. This period is divided into six sequences of identical duration. The driving of the 6 switches is different in each of these sequences. The signals of switches K1 to K3 are shown. They are driven with a variation of the duty cycle between a minimum duty cycle value and a maximum duty cycle value. The signals at the terminals U, V and W (shown in FIG. 3) are phase-shifted by 120° from one another and represented by curves K1, K2 and K3. The signals for driving the switches K1 and K4, K2 and K5, K3 and K6 are complementary to one another. Thus, the duty cycle of the control signal for the switch K1 is at a maximum when the duty cycle of the control signal for the switch K4 is at a minimum, and the duty cycle of the control signal for the switch K4 is at a maximum when the duty cycle of the control signal for the switch K1 is at a minimum. This drive logic makes it possible to generate a first electric power supply signal to the motor at a first frequency equal to 1/(T6−T0). The first electrical signal comprises three phase signals producing, at each of the windings of the stator, signals that are phase-shifted by 120° in relation to one another. The three signals at the windings are alternating signals shown on the last three timing diagrams of FIG. 7.

Assuming a first electrical signal having a frequency of 1046 Hz in order to emit a sound (corresponding to a musical note C) and assuming that the signal is able to be produced using a PWM technique at 50 kHz, it is seen that it is possible to obtain 48 modulation commands per period of the first electrical signal, that is to say 8 modulation commands per sequence of the first electrical signal, for example 8 modulation commands between T0 and T1. Assuming that the PWM frequency is constant, it is clear that the higher the sound frequency, the fewer commands there are available per period to construct the first electrical signal. This number of commands has a direct effect on the quality of the sound that is emitted: the more modulation commands there are in a period, the less the weight of each command. In other words, if a command is missed on one phase and is transferred to another phase, an erroneous command is obtained and the signal will be less disturbed and the influence of this error will be smaller the higher the number of commands. In other words, at a constant PWM frequency, the smaller the period or pseudo-period of the first electrical power supply signal to the motor, the more this period or pseudo-period of the first signal is sampled by a small number of samples. As already explained, it is therefore desirable to have a PWM frequency that is as high as possible in order to obtain sufficient sampling of the first signal regardless of the period or the pseudo-period of the first signal.

The first electrical signal could also be a sinusoidal electrical signal.

The execution mode of the electronic control method may comprise three successive operating modes as shown in FIG. 8. In the first mode M1, an electrical signal is applied to the motor in order to make it rotate, as explained above. In a second mode M2, the supply of power to the motor is cut. The motor stops. In a third mode M3, the first electrical signal is applied to the motor such that the electric motor and/or the structure emits the first sound signal without the rotor of the motor rotating in relation to the stator of the motor. This supply of power is performed in open-loop mode, that is to say without taking into account the position of the rotor.

It is noted that sounds may be produced by a motor with very small modifications to an existing installation. It is enough to make software modifications so that the inverter supplying power to the motor is able to deliver a first electrical signal without taking into account the position of the rotor of the motor, and possibly at a frequency far higher than the frequency of a power supply signal allowing the motor to rotate at its nominal speed. It is noted that the power supply signals to the motor differ only in terms of their frequencies between the operating modes M1 and M3.

The invention also relates to a computer program product able to be downloaded from a communication network and/or recorded on a data medium able to be read by a computer and/or able to be executed by a computer, characterized in that it comprises computer program code instructions for implementing the method as described above when the program is executed by a computer and/or in that it comprises instructions that, when the program is executed by a computer, prompt same to implement the method as described above.

The invention also relates to a data recording medium, able to be read by a computer, on which is recorded a computer program comprising program code instructions for implementing the method as described above or a computer-readable recording medium comprising instructions that, when they are executed by a computer, prompt same to implement the method as described above.

The method for electronically controlling the supply of power to a motor or the method for generating sound by way of a motor is particularly effective for brushless magnet motors and wound-rotor motors. A DC current motor controlled in this way would inevitably rotate. In order to prevent it from rotating, it would then be necessary to under-supply it with power. For magnet-free asynchronous or synchronous-reluctance motors, the sound generation method is less efficient since the absence of the field of the magnets limits the vibration and acoustic level.

The first electrical signal may also have a first frequency that makes it possible to produce an animal deterrence sound, in particular a first ultrasonic sound signal. In such a case, the method comprises a step of defining the first electrical signal allowing the motor and/or the structure to emit an ultrasonic sound signal without the rotor of the motor rotating in relation to the stator of the motor and a step of supplying power to the motor with the first electrical signal. Such a signal could be emitted periodically at a determined interval or more continuously. Beyond 16 kHz or 20 kHz, the electrical control signal makes it possible to create an ultrasonic signal. This could in particular be used to prevent a pet from staying between a shutter and a window and being trapped there.

The method that is the subject of the invention may be applied to various technical fields, in particular to the field of home automation equipment, to the field of automotive equipment and to the field of household appliances.

In the home automation field, electric motors are used to create actuators. In most home automation applications, it is desired for these motors to be discrete and for them to produce a minimum amount of noise when their rotors rotate in relation to their stators. By contrast, it is sought for them to produce sounds in particular operating modes in which their rotors do not rotate in their stators.

In some applications, the motor is not linked directly to the user, that is to say that the sound emitted by the motor itself is not sufficiently audible. Thus, in these applications, the noise emitted by the motor is relatively unimportant. On the other hand, the motor is inserted into a tube of the actuator, which is itself inserted into a home automation device. Finally, it may be the home automation device and/or the structure of the building that, when subjected to vibrations of the motor, irradiates the surroundings by emitting sounds as a result of the vibrations produced by the motor.

The device is for example a home automation device for closure, concealment, sun protection or screening purposes. It comprises for example a winding tube 3 to which a shutter 4 is linked. The home automation device may in particular be a roller shutter or a blind or a door or a gate or a screen.

In the case of a home automation device, the structure surrounding the motor or linked to the motor may in particular include all or some of the following elements linked directly or indirectly to the motor:
a mobile element 3, 4 intended to be driven by the motor; and/or
a support 10 intended to receive the motor; and/or
a trunk or box in which the motor and the mobile element are enclosed in the folded or wound-up position; and/or
a wall or walls of the building on which the home automation system is installed; and/or
a resonant element 9 attached to the motor or to one of the elements listed above in this list.

As seen above, the sounds that are emitted have meanings. In other words, each emitted sound signifies information. The information may in particular comprise:
information confirming a setting or a configuration, in particular an end position setting, pairing of a remote control with the actuator,
fault information,
error information,
anomaly information, in particular control information that contradicts management logic (for example thermal),
information for detecting the crossing of a door threshold (chime, bell),
cycle start/end information,
orientation information (orientation of a device to be fixed in a building),
information for adjusting the motorization of a bay window, alarm information in the event of intrusion into a space (alarm siren).

In the technical field of motor vehicles, the information may in particular comprise:
space positioning information (reversing radar of a vehicle), information about crossing a ground marking line on a roadway,
information about the opening/closure of doors, or information about the location of a car in a parking lot,
diagnostic information (seatbelt not fastened, empty fuel tank),
an audible warning, in particular by vibrating the traction motor of an electric or hybrid vehicle.

In the technical field of household appliances, the information may in particular comprise:
diagnostic information (lack of dishwasher salt, lack of dishwasher fluid, etc.),
state or state change information, in particular end of cycle information.

When supplying power to the motor in order to emit a siren sound, that is to say an alarm signal, it may be particularly beneficial to use the home automation device. Specifically, a frequency scan may be performed in order to determine the frequencies of vibrations of the motor that generate sounds at a high sound volume level. This makes it possible to maximize the emitted sound level.

Thus, when it is desired to generate an alarm siren sound, it is sought to maximize the sound level or volume of the sound. To this end, the method comprises defining the first electrical signal allowing the motor to emit an alarm sound signal without the rotor of the motor rotating in relation to the stator of the motor. In order to maximize the sound level or volume of the sound, it is in particular possible to define the first electrical signal such that it generates resonance of the electric motor and/or of the structure or so as to create excitation at a frequency close to a resonant frequency of the electric motor and/or of the structure, in particular between 0.8 times and 1.2 times the resonant frequency. Resonance is preferably defined as being a local maximum of sound volume (over a frequency interval).

As an alternative, it is possible to generate a first electrical signal the first frequency of which evolves over time and periodically between a first lower bound and a second upper bound. The evolution is preferably progressive. The evolution may be performed continuously in terms of frequency or in hops by selecting various discrete frequency values one after another. The first lower bound is for example greater than or equal to 500 Hz, or even greater than or equal to 1000 Hz, and/or the second upper bound is for example less than or equal to 5000 Hz, or even less than or equal to 10 000 Hz. During these frequency scans, the motor and/or the structure are then necessarily excited at one or more frequencies that generate sounds with a high sound level or sound volume.

Again as an alternative, it is possible to empirically choose at least one first frequency of the first electrical signal that will then be used when it is desired to emit an alarm siren sound. To this end, the method may comprise a configuration phase in which:
In a first sub-step, a second electrical signal is defined the frequency of which evolves over time and, possibly periodically, between a first lower bound and a second upper bound. The evolution is preferably progressive. The evolution may be performed continuously in terms of frequency or in hops by selecting various discrete frequency values one after another. The first lower bound is for example greater than or equal to 500 Hz, or even greater than or equal to 1000 Hz, and/or the second upper bound is for example less than or equal to 5000 Hz, or even less than or equal to 10 000 Hz;
In a second sub-step, the motor is supplied with power by the second electrical signal;
In a third sub-step, the user indicates, through an appropriate action, for example through an action on a button on a motor control point, the time when the motor and/or the structure emit a sound that is suitable for said user in the second sub-step;
In a fourth sub-step, the frequency of the second electrical signal corresponding to the time indicated by the user is recorded as the first frequency of the first electrical signal to be used to subsequently emit the first sound signal, in particular the first siren sound signal.

Advantageously, it is possible to reiterate the third and fourth sub-steps, or even all of the previous sub-steps, one or more times in order to define one or more complementary frequencies to be used in the first electrical signal in order to produce a first chosen sound signal having several sound frequencies, in particular a first alarm siren sound signal.

One exemplary embodiment of an alarm sound signal or of an alarm siren sound signal is described below with reference to FIG. 9. In this example, the frequency of the first electrical signal evolves periodically between 500 Hz and 5 kHz. The frequency evolution period is 1 second.

The electronic control device or more generally the actuator system may optionally comprise a wired or wireless communication element for sending a control order directly or indirectly to at least one other actuator system also comprising a second motor. This control order is advantageously a control order to supply power to the second motor in order to produce a sound, in particular an alarm siren sound, without the second motor rotating.

In all of the embodiments, the sound is radiated by a mechanical structure.

The structure may be the structure of the motor itself. The latter then emits a sound in line with the command. It is usually sought to avoid resonance of the motor, in particular in a normal operating mode intended to drive the mobile element. In one particular operating mode of the motor intended to emit sounds, in order to maximize the radiated noise, it is contemplated to bring about one or more particular resonances of the motor, of its casing or of its yoke for example. To this end, it is necessary to create spatial and temporal coincidence between the excitation and the response of the structure. This means creating a conjunction between a waveform and an excitation frequency with a natural mode and a natural frequency of the motor. In order to maximize the noise, small wave numbers will be preferred, and particularly but not exclusively order 0, as well as frequencies between 1 kHz and 5 kHz, which correspond to the interval in which the human ear is most sensitive. More generally, it is possible to produce sounds in the range of frequencies audible to the human ear, or even the ultrasonic frequency range.

The structure mentioned may also be the support 10 or the equipment for receiving the motor. In this case too, it is possible to maximize the sound level by seeking a resonance of the structure. This may be achieved by frequency scanning. This may be continuous in the life of the product; this is then a siren whose amplitude varies with frequency by virtue of the impedance of the circuit and the maintenance of the duty cycle of the PWM. Of course, it is possible to slave it in order to obtain a constant amplitude. The frequency scanning may also be supervised by a machine or a person. The frequency at which the response is at a maximum may be selected as the useful frequency for transmitting the information. In the case of supervision by a person, the selected frequency is not necessarily the one where the response is at a maximum, but could be the one where the sound or a succession of sounds is the most pleasant.

The structure may comprise the mobile element to be driven and the same principles apply.

Finally, the structure may be an external element added to the equipment in order to act as a means for emitting and maximizing the noise. The installation or the actuator system or the actuator then comprises an additional added mechanical structure including an element 9 resonating at a sound frequency audible to the human ear or ultrasonic frequency. For example, such a frequency is between 500 Hz and 20 kHz. This element may for example act in a manner similar to a tuning fork, such that, following an excitation, it vibrates at its natural frequency and therefore radiates a sound into its surroundings. This element may be added only to emit a noise.

The method described above makes it possible to use a motor as a vibration generator by driving at least one of the phases without the rotor rotating in relation to the stator. It is therefore possible to generate vibrations and therefore sounds without any additional physical means other than the pre-existing motor and electrical converter to create structure-borne/airborne noise. It is enough for example to program software means of an inverter to obtain such a result.

Other application examples may exist in a wide variety of fields.

For example, household appliances could benefit from this invention by using the motors that are present, such as a washing machine motor, or else a pump motor of a dishwasher, or even a motor of a blender.

These products are generally equipped with an electronic component such as a buzzer or loudspeaker in order to emit sounds signifying for example when a cycle starts or ends, or else to signal an error. By virtue of the present invention, the operation of these devices for users would be exactly the same, but a reduction in the number of components that are used would be noted. This is beneficial from an eco-design point of view and from the point of view of the cost price of the devices.

In the same way, the invention may be applied to the automotive field, which incorporates numerous actuators, starting with motor systems for rear-view mirrors, or for windscreen wipers, or even for ventilation.

In this case too, various buzzers may advantageously be replaced using the method that is the subject of the invention. It is also possible to contemplate combinations of sounds coming from several motors located in the vehicle for a sound volume effect.

The invention could also advantageously be applied to the field of robotics, which uses numerous motors. Sounds could be emitted by certain inactive motors while others are active, this being done for example in order to signal a movement of the robot to the surroundings. In the same manner, error information could be reported in this way.

1. A method for electronically controlling the supply of electric power to a polyphase motor, the method comprising:
supplying power to at least one phase of the motor with a first periodic or pseudo-periodic electrical signal capable of causing at least one selected from the group consisting of the motor and a structure linked to the motor to emit a first sound signal,
wherein the supply of power takes place while a rotor of the motor is kept stationary in relation to a stator of the motor.

2. The method as claimed in claim 1, wherein the motor is kept stationary by at least one selected from the group consisting of:
supplying power to several phases of the motor with a first electrical signal generating, in the motor, a magnetic field rotating at a frequency greater than the stall frequency of the motor;
supplying power to the at least one phase of the motor with a first electrical signal generating, in the motor, a static and pulsating magnetic field;
supplying power to several phases of the motor with a first electrical signal generating, in the motor, two magnetic fields rotating in opposite directions at the same frequency;
blocking the rotor by way of a brake or any other blocking member;
braking or by loading the motor so as to increase the resistance of the load driven by the motor.

3. The method as claimed in claim 1, wherein the method comprises:
defining a first frequency of a first portion of the first electrical signal on the basis of a first portion of the first sound signal to be emitted by the at least one selected from the group consisting of the motor and the structure linked to the motor, and
supplying power to the motor with the first portion of the first electrical signal at the defined first frequency.

4. The method as claimed in the claim 3, wherein the method comprises:
defining a second frequency of a second portion of the first electrical signal on the basis of a second portion of the first sound signal to be emitted by the at least one selected from the group consisting of the motor and the structure linked to the motor, and
supplying power to the motor with the second portion of the first electrical signal at the defined second frequency.

5. The method as claimed in claim 1, wherein the method comprises defining several different electrical signals capable of causing the at least one selected from toe group consisting of the motor and the structure linked to the motor to emit several sound signals without a rotor of the motor rotating in relation to a stator of the motor, each sound signal being associated with particular information intended for a user.

6. The method as claimed in claim 1, wherein the method comprises defining an electrical signal allowing the at least one selected from the group consisting of the motor and the structure linked to the motor to emit an animal deterrence sound signal without the rotor of the motor rotating in relation to the stator of the motor.

7. The method as claimed in claim 1, wherein the method comprises defining an electrical signal allowing the at least one selected from the group consisting of the motor and the structure linked to the motor to emit an alarm sound signal without the rotor of the motor rotating in relation to the stator of the motor.

8. The method as claimed in claim 1, wherein the method comprises defining the first electrical signal having a frequency evolving progressively over an entire frequency range.

9. The method as claimed in claim 1, wherein the method comprises a configuration phase comprising:
defining a second electrical signal having a frequency evolving progressively over an entire frequency range extending from 500 Hz to 10 000 Hz;
supplying the motor with power by the second electrical signal;
receiving an indication by the user of a time when the at least one selected from the group consisting of the motor and the structure linked to the motor emits a sound that is suitable for the user while the motor is supplied with power by the second electrical signal;
recording a frequency of the second electrical signal corresponding to the time indicated by the user as the frequency of the first electrical signal to be used to subsequently emit the first sound signal.

10. The method as claimed in claim 1, wherein the first electrical signal is a signal sampled at a frequency greater than or equal to 16 kHz, or wherein the first electrical signal is a polyphase signal each phase of which is supplied with power by a signal sampled at a frequency greater than or equal to 16 kHz.

11. The method as claimed in claim 1, wherein the first electrical signal is a trapezoidal signal or a pseudo-sinusoidal signal or a sinusoidal signal, or wherein the first electrical signal is a three-phase signal each phase of which is trapezoidal or pseudo-sinusoidal or sinusoidal.

12. The method as claimed in claim 1, wherein the motor is a three-phase electric motor and wherein the first power supply signal is generated by a three-phase inverter.

13. An electronic control device for controlling the supply of power to a polyphase motor, the device comprising at least one selected from the group consisting of hardware and software elements implementing a method comprising:
supplying power to at least one phase of the motor with a first periodic or pseudo-periodic electrical signal capable of causing at least one selected from the group consisting of the motor and a structure linked to the motor to emit a first sound signal,
wherein the supply of power takes place while a rotor of the motor is kept stationary in relation to a stator of the motor.

14. An actuator comprising a mechanical structure comprising a resonant element resonating at a given frequency.

15. An actuator system comprising an electronic control device as claimed in claim 13 and an actuator.

16. (canceled)

17. A non-transitory data recording medium, able to be read by a computer, on which there is recorded a computer program comprising program code instructions for electronically controlling the supply of electric power to a polyphase motor that, when they are executed by a computer, cause the computer to implement a method comprising:
supplying power to at least one phase of the motor with a first periodic or pseudo-periodic electrical signal capable of causing at least one selected from the group consisting of the motor and a structure linked to the motor to emit a first sound signal,
wherein the supply of power takes place while a rotor of the motor is kept stationary in relation to a stator of the motor.

18. The method as claimed in claim 5, wherein the respective sound signals are associated with the respective following information intended for the user:
information confirming a setting or a configuration,
fault information,
error information,
anomaly information.

19. The method as claimed in claim 6, wherein the animal deterrence sound signal is an ultrasonic sound signal.

20. The method as claimed in claim 7, wherein the alarm sound signal is an electrical signal allowing the at least one selected from the group consisting of the motor and the structure linked to the motor to resonate.

21. The method as claimed in claim 8, wherein the frequency range extends from 1000 Hz to 5000 Hz.
